(19) United States
(12) Patent Application Publication
(10) Pub. No.: US 2010/0315349 A1
(43) Pub. Date: Dec. 16, 2010

(54) VEHICLE COMMANDER CONTROL SWITCH, SYSTEM AND METHOD

(76) Inventor: Dave Choi, Marysville, OH (US)

Correspondence Address: Rankin, Hill & Clark LLP, 23755 Lorain Road, Suite 200, North Olmsted, OH, 44070, US

(21) Appl. No.: 12/483,928

(22) Filed: Jun. 12, 2009

(51) Int. Cl. G06F 3/041; G09F 13/04; G06F 3/033; G06F 3/048

(52) U.S. Cl. 345/173; 362/97.1; 345/184; 715/863; 715/784

(57) ABSTRACT

A vehicle commander control switch, system and method includes a touch pad having a touch surface for receiving touch input thereon. The touch surface has a first inner zone and a second outer zone disposed outwardly relative to the first inner zone. A touch pad signal generator detects the location of the touch input on the touch surface and generates signals corresponding thereto. The control unit is operatively connected to the touch signal generator. The control unit receives signals from the touch signal generator and controls display content on a display device. The control unit scrolls the display content on the display when the touch pad signal generator detects the touch input in the second zone and sends the signals to the control unit corresponding to the touch input in the second zone.

### BACKGROUND

The present disclosure relates to a commander control switch, system and method for a vehicle, such as the type used in association with a display device.

Some vehicle display systems employ touch screens; however, interacting with a touch screen can cause a driver to take his or her eyes off the road for too long. To improve safety, the display can be provided with an operating member or a multi-position switch configured to move a cursor on the display screen and/or make a selection among a plurality of processing items or menus displayed on the display screen. Some such operating members are displaceable in an axial direction and/or rotatable around the axial direction. Selection can be made among the various processing items on the display screen in accordance with an inputting operation by the operating member. Some vehicle display systems employ a combination including an interactive touch screen and an operating member or multi-position switch.

Interactive touch screens in vehicles are common, but still continue to be somewhat difficult to design and use since the display visibility is sometimes compromised (e.g., a hooded screen cannot be used), placement is limited (e.g., the display must be in reach of the driver), and the sensitivity of the touch screen is sometimes an issue (e.g., not sensitive enough or too sensitive). In addition, the large majority of vehicle touch screens are flat, which can create an ergonomic concern. Size can also be an issue, particularly since the users often have to constantly swipe the surface to scroll around a large map when used in association with a vehicle navigation system.

### BRIEF DESCRIPTION

According to one aspect, a vehicle commander control switch includes a touch pad having a touch surface for receiving touch input thereon. The touch surface has a first inner zone and a second outer zone disposed outwardly relative to the first inner zone. The control switch also includes a touch pad signal generator for detecting the location of the touch input on the touch surface and generating signals corresponding thereto. The touch pad signal generator has a scroll mode wherein the touch pad signal generator generates a scroll command signal when the touch input is on the second zone that corresponds to a location of the touch input on the second outer zone.

According to another aspect, a commander control switch system is provided for a vehicle. More particularly, in accordance with this aspect, the system includes a touch pad having a touch surface for receiving touch input thereon. The touch surface includes a first central zone and a second zone annularly surrounding the first central zone. The system also includes a touch pad signal generator for detecting the location of the touch input on the touch surface and generating signals corresponding thereto. In addition, the system includes a control unit and a display device for displaying display content. The control unit is operatively connected to the touch signal generator for receiving the signals therefrom, and is also operatively connected to the display device for controlling the display content on the display device. The control unit scrolls the display content on the display device when the touch pad signal generator detects the touch input in the second zone and sends the signals to the control unit corresponding to the touch input in the second zone.

According to still another aspect, a commander control switch method includes providing a touch pad having a touch surface including a first central zone and a second zone annularly surrounding the first central zone, generating scroll command signals when touch input is received on the second zone of the touch pad, receiving the scroll command signals from the touch pad, displaying display content on a display, and scrolling the display content on the display when the scroll command signals are received.

### BRIEF DESCRIPTION OF THE DRAWINGS

FIG. 1 is a perspective view of a vehicle commander control switch.

FIG. 2 is a top plan view of the vehicle commander switch of FIG. 1.

FIG. 3 is a cross section of the vehicle commander control switch taken along the line 3-3 of FIG. 1.

FIG. 4 is a schematic view of a commander control switch system for a vehicle, including the vehicle commander control switch of FIGS. 1-3.

FIG. 5 is a flow diagram of a commander control switch method.

### DETAILED DESCRIPTION

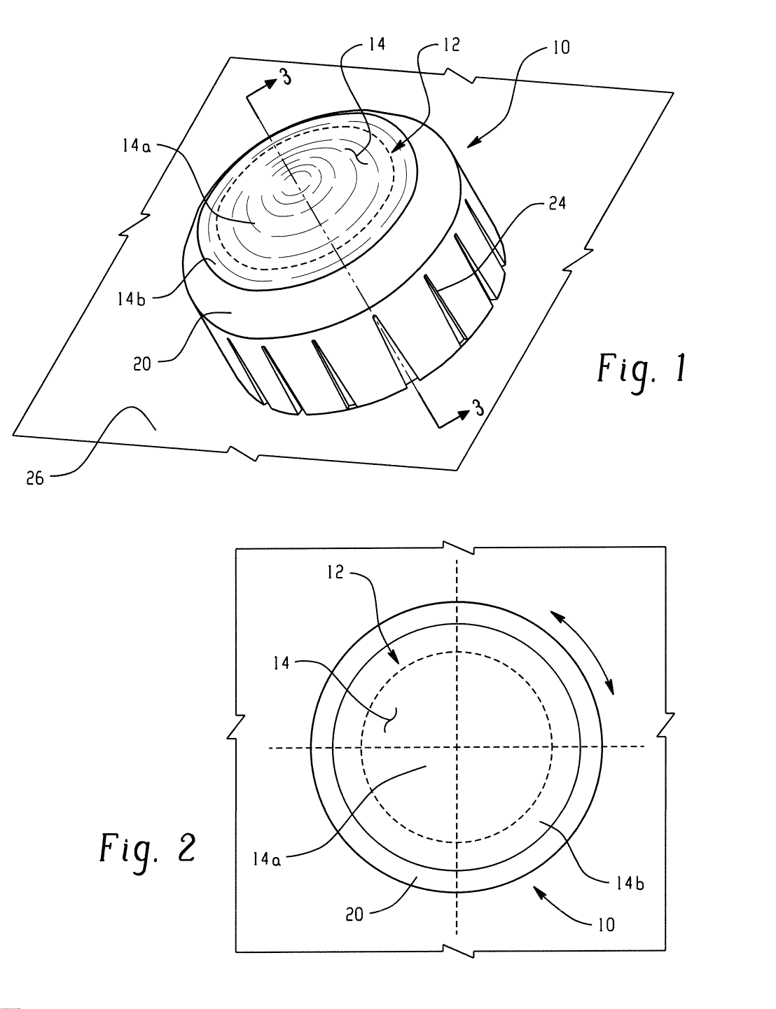

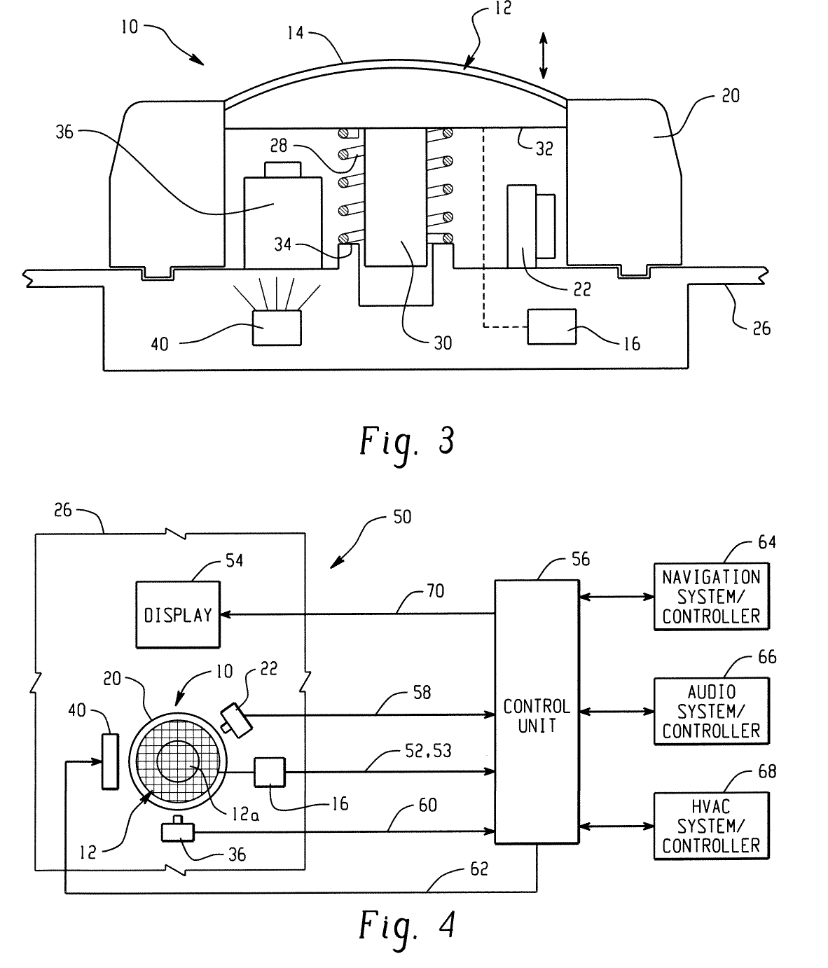

Referring now the drawings, wherein the showings are only for purposes of illustrating one or more exemplary embodiments and not for purposes of limiting same, FIGS. 1 and 2 schematically illustrate a vehicle commander control switch, which is generally designated by reference numeral 10. The control switch 10 includes a touch pad 12 having a touch surface 14 for receiving touch input thereon. In one embodiment, the touch pad 12 can include capacitance sensors 12a for determining where touch input occurs on the touch surface 14. The touch surface 14 has a first inner or central zone 14a and a second outer zone 14b disposed outward relative to the first inner zone 14a. With additional reference to FIG. 3, the vehicle commander control switch 10 further includes a touch pad signal generator 16 for detecting the location of the touch input on the touch surface 14 and generating signals corresponding thereto. As will be described in more detail below, the touch pad signal generator 16 has a scroll mode wherein the touch pad signal generator 16 generates a scroll command signal (e.g., scroll command signal 52 of FIG. 4), when the touch input is on the second outer zone 14b, which corresponds to a location of the touch input on the second outer zone 14b. Of particular advantage, the touch pad signal generator 16 can continuously generate the scroll command signal while touch input is on the second outer zone 14b.

As shown in the illustrated embodiment, the touch surface 14 can be a continuous surface across and between the first and second zones 14a and 14b. That is, there are no physical or tactile delineations at the boundary between the first and second zones 14a, 14b on the touch surface 14 (e.g., no ridges, grooves, depressions, etc.). Accordingly, as best shown in FIG. 3, the touch surface 14 can be smooth without interruptions across its entire diameter. While surface 14 is continuous across the zones 14a,14b, the zones can be distinguished from one another through other means. For example, the zones 14a,14b could vary in color, texture, material composition, etc. Also, different backlighting could be applied to the zones 14a,14b. In addition, the touch surface 14 can be generally round and convex (as shown in the illustrated embodiment), though this is not required. When the touch surface 14 is round, as shown in the illustrated embodiment, the first zone 14a can have a generally circular configuration and a second zone 14b can have a generally annular configuration that annularly surrounds the first zone 14a.

Of course, other configurations are contemplated. For example, the touch surface 14 could have a square or rectangular configuration (not shown) wherein the inner zone 14a has a square or rectangular configuration with the outer zone 14b having a corresponding square or rectangular configuration surrounding the inner zone. Alternatively, one or both of these zones 14a, 14b can be broken up. In one such example (not shown), the outer zone 14b includes four separated areas, such as a first area provided above the inner zone 14a, a second area provided to the right of the area 14a, a third zone provided below area 14a and a fourth zone provided to the left of area 14a (all directions relative to the plan view of FIG. 2). These separated areas could still be continuous with zone 14a, but can be separated relative to one another.

The vehicle commander control switch 10 can further include an annular rotary knob 20 disposed annularly around the touch pad 12 and rotatably movable relative thereto. As shown, the touch pad 14 can be disposed radially within the rotary knob 20. In association with the rotary knob 20, the switch 10 can also include a rotational signal generator 22 disposed on or adjacent the rotary knob 20 for detecting relative rotation of the rotary knob 20 and generating rotational signals (e.g., rotational signals 58 in FIG. 4) corresponding thereto. As shown in FIG. 1, the rotary knob 20 can include indentations or recesses 24 to facilitate gripping of the rotary knob 20 when rotation thereof is desired.

The vehicle commander control switch 10 can also include a vehicle support structure 26 on or in which the touch pad 12 can be mounted. The vehicle support structure 26 could be, for example, the dashboard or console area of a vehicle, or some other area. In the illustrated embodiment, the touch pad 12 is displaceable relative to the support structure 26 between a first position (e.g., a rest position) and a second depressed position. A bias mechanism, such as coil spring 28, can be connected to the support structure 26 to urge the touch pad 12 toward the first position. For example, in the schematically illustrated embodiment of FIG. 3, the coil spring 28 is received annularly around touch pad stem portion 30 and disposed axially between an underside 32 of the touch pad 12 and shoulder portion 34 of the support structure 26. Of course, other configurations and bias mechanisms can be used for urging the touch pad 12 toward its first rest position. The touch pad movement signal generator 36 can be provided for detecting depression of the touch pad 12 when the touch pad 12 is moved to the second position and generating a depression signal (e.g., depression signal 36 of FIG. 4) corresponding thereto.

The vehicle commander control switch 10 can also include backlighting 40 for illuminating the touch pad 12 and/or the rotary knob 20. The backlighting 40, which is illustrated schematically in FIG. 3, can include a plurality of colors with each of the plurality of colors corresponding to one of a plurality of system modes of the touch pad 12 such that the touch pad 12 is illuminated with a particular color that corresponds to a particular system mode of the touch pad. For example, the plurality of system modes can include two or more of a navigation mode, an audio mode and an HVAC mode, and could include additional or other modes. Each of the plurality of colors could correspond to these modes. For example, the backlighting could apply red illumination for the navigation mode, amber illumination for the audio mode and/or green illumination for the HVAC mode.

With reference to FIG. 4, a commander control switch system 50 is schematically illustrated for a vehicle. A system 50 includes a vehicle commander control switch, such as switch 10 of FIGS. 1-3, which includes touch pad 12 having touch surface 14 for receiving touch input thereon. The system 50 additionally includes a touch pad signal generator, such as touch pad signal generator 16 of FIG. 3, for detecting the location of touch input on the touch surface and generating signals 52 corresponding to such touch input. As shown, the system 50 further includes a display device 54 for displaying display content and a control unit 56 for controlling communications and operations of the system 50. Though not illustrated, the control unit 56 can include an input/output interface for communicating with the signal generators 16, 22, 36, the backlighting 40, and/or the display device 54. In addition, the control unit 56 can include a CPU and a memory. The display device 54 and the control unit 56 are operatively connected to one another, and particularly the control unit 56 is operatively connected to the display device 54 for controlling the display content on the display device 54.

The control unit 56 is also operatively connected to the touch signal generator 16 for receiving the signals 52 therefrom. As will be described in more detail below, the control unit 56 scrolls the display content on the display device 54 when the touch pad signal generator 16 detects touch input in the second zone 14b and sends the signals 52 to the control unit 56 corresponding to the touch input in the second zone 14b. The display device 54 can be mounted in the same vehicle support structure 26 as is the commander control switch 10, though this is not required (e.g., display 54 could be mounted in a dashboard portion of the vehicle and the commander switch 10 could be separately mounted in a console portion of the vehicle).

As shown, the control unit 56 can be operatively connected to the rotational signal generator 22 for receiving rotational signals 58 therefrom. Accordingly, the rotational signal generator 22 detects relative rotation of the rotary knob 20 (e.g., relative to the touch pad 12 and/or the vehicle support structure 26) and generates rotational signals 58 corresponding thereto. These signals 58 are sent to and received by the control unit 56. The control unit 56 can also be operatively connected to the touch pad movement signal generator 36 for receiving movement signals 60 therefrom. Accordingly, when the touch pad 12 is axially displaced from the first position to the second position overcoming the urging of the bias mechanism (e.g., spring 28), and the touch pad movement signal generator 36 detects such movement of the touch pad 12 into the second position and generates the corresponding movement signal 60, such signal is sent to and received by the control unit 56.

Still further, the control unit 56 can be operatively connected to the backlighting 40 for the touch pad 12 and/or the rotary knob 20. As already indicated herein, the backlighting 40 can include a plurality of colors (e.g., at least a first color and a second color). The backlighting 40 can be controlled by the control unit (e.g., backlighting command signal 62) such that in one example the backlighting 40 illuminates the touch pad 12 in a first color when the touch pad 12 is operated in a first mode (e.g., navigation mode) and illuminate the touch pad in a second color when the touch pad 12 is operated in a second mode (e.g., audio or HVAC mode). Additional colors can be used for additional modes if desired.

The control unit 56 can additionally be operatively connected to one or more of a navigation system or controller 64, an audio system or controller 66, and an HVAC system or controller 68. Alternatively, the control unit 56 can be one of the controllers of the navigation system, audio system or HVAC systems. While in the illustrated embodiment, the control unit 56 is shown as being operatively connected to each of the navigation system or controller 64, the audio system or controller 66 and the HVAC system or controller 68, it is to be appreciated and understood by those skilled in the art that fewer systems/controllers could be employed or additional systems/controllers could be employed.

In an exemplary embodiment, input from the commander control switch 10 corresponds to a particular system (e.g., system 64, 66, or 68) depending on a mode in which the control unit 56 is in. For example, the control unit 56 can have a navigation mode wherein input from the commander control switch 10, including touch input from the touch pad 12, operates the vehicle navigation system 64. In this exemplary embodiment, the touch pad signal generator 16 can be in the scroll mode when the control unit 56 is in the navigation mode such that the touch pad signal generator 16 generates the signal 52 as a scroll command signal when touch input is on the second outer zone 14b, and wherein the scroll command signal corresponds to a location of a touch input on the second outer zone 14b. The touch pad generator signal 16 can generate gesture command signals 53 when the touch input on the touch pad 12 is in the first inner zone 14a. These gesture command signals 52 are received by the control unit 56.

In one example, the display device 54 displays a map when the control unit 56 is in the navigation mode. In this example, the scroll command signal 52 is generated by the touch pad signal generator 16 when the touch input is on the second outer zone 14b with the control unit 56 in navigation mode and the touch pad signal generator is in the scroll mode. Accordingly, the control unit 56 scrolls the map on the display device 54 via display command signal or signals 70. In particular, the control unit 56 scrolls the map on the display device 54 continuously while the scroll command signal 52 is received (i.e., scrolling occurs continuously while touch input continues on the second zone 14b). The control unit 56 also reconfigures the map on the display device 54 based on the gesture command signals 53, which are received from the signal generator 16 when touch input is on the first zone 14a.

The gesture command signals 53 can include zoom gesture command signals, such as zoom in and zoom out commands. For example, the user can place two fingers on the first central zone 14a and spread those fingers apart to zoom the map of the display device 54 out or can move the two fingers toward one another to zoom in on the map. When the touch input is on the second zone 14b and scrolling of the map on the display device 54 occurs, a direction along which the map is scrolled can correspond to a location of a touch input upon the second outer zone 14b. For example, when a top portion (relative to FIG. 2) of the second zone 14b is touched, the map on the display device 54 can be scrolled upwardly. Accordingly, a direction of scrolling of the display content on the display device 54 by the control unit 56 can correspond to a location of the touch input in the second zone 14b. Advantageously, control unit 56 continuously scrolls the display content on the display device 54 while the touch pad signal generator 16 continuously detects touch input in the second zone 14b and continuously sends signals (e.g., signals 52) to the control unit 56 corresponding to the touch input in the second zone 14b.

The first central zone 14a can also be used for conventional dragging of the map on the display 54. For example, a user can place a single finger within the first zone 14a and drag that finger to another location in the zone 14a to drag the map, wherein a direction of the dragging of the map will correspond to a direction of dragging across the first zone 14a. In contrast, touching the second zone 14b allows auto-scrolling of the map on the display device 54. Auto-scrolling eliminates or reduces the constant swiping motion required by users of most current systems and creates an easier to use and more ergonomic platform. A selection or enter function can correspond to the touch pad 12 being moved to the second position, wherein the movement detector 36 relays signal 60 to the control unit 56. Alternatively, movement of the touch pad 12 and detection thereof by signal generator 36 can be replaced by input being received through the touch surface 12, such as by a tap on the touch surface 12.

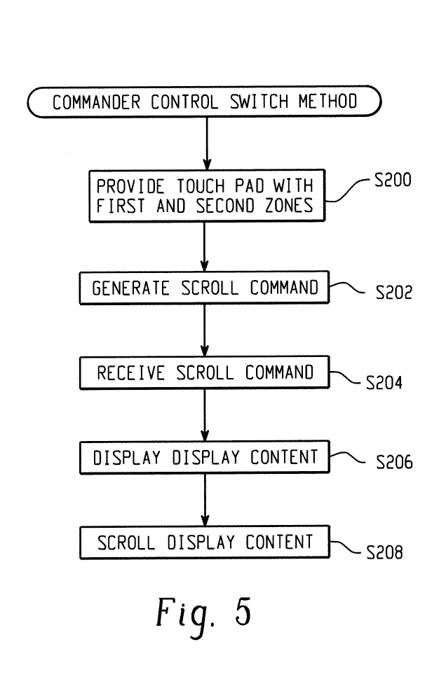

With reference now to FIG. 5, a commander control switch method will be described. The method of FIG. 5 can be applied to the system 50 of FIG. 4. In the method, the touch pad, such as touch pad 12 having a touch surface 14 including first central zone 14a and second zone 14b annularly surrounding the first central zone 14a, can be provided (S200). Scroll command signals, such as signals 52, can be generated when touch input is received on the second zone 14b of the touch pad 12 (S202). The scroll command signals 52 can be received by the control unit 56 from the touch pad 12 (S204). Display content can be displayed on a display device 54 as commanded by the control unit 56 (S206). The display content on the display device 54 can be scrolled when the scroll command signals 52 are received by the control unit 56 (S208), wherein the scroll command signals 52 corresponding to touch input on the second zone 14b.

It is to be appreciated that in connection with the particular exemplary embodiments presented herein, certain structural and/or functional features are described as being incorporated in defined elements and/or components. However, it is calculated that these features, to the same or similar benefit, also may likewise be incorporated in common elements and/or components or separated, where appropriate. For example, the controller 56 could be distributed throughout the system 50.

It is also to be appreciated that different aspects of the exemplary embodiments may be selectively employed as appropriate to achieve other alternative embodiments suited for the desired applications, the other alternate embodiments thereby realizing the respective advantages of the aspects incorporated herein. It is also to be appreciated that particular elements or components described herein may have their functionality suitably implemented via hardware, software, firmware, or in combination. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein are distinct from one another may be physically or functionally combined where appropriate. For example, the navigational system or controller 64 could be combined with the control unit 56.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A vehicle commander control switch, comprising:
a touch pad having a touch surface for receiving touch input thereon, said touch surface having a first inner zone and a second outer zone disposed outwardly relative to said first inner zone; and
a touch pad signal generator for detecting the location of said touch input on said touch surface and generating signals corresponding thereto, said touch pad signal generator having a scroll mode wherein said touch pad signal generator generates a scroll command signal when said touch input is on said second outer zone that corresponds to a location of said touch input on said second outer zone.

2. The vehicle commander control switch of claim 1 wherein said touch surface is a continuous surface across and between said first and second zones.

3. The vehicle commander control switch of claim 2 wherein said touch surface is generally round and convex.

4. The vehicle commander control switch of claim 2 wherein said first and second zones are distinguished from one another by having at least one of: varying colors, varying textures and varying backlighting.

5. The vehicle commander control switch of claim 1 wherein said first zone has a generally circular configuration and said second zone has a generally annular configuration that surrounds said first zone.

6. The vehicle commander control switch of claim 5 further including:
a rotary knob disposed around said touch pad and rotatably movable relative thereto; and
a rotational signal generator disposed on or adjacent said rotary knob for detecting relative rotation of said rotary knob and generating rotational signals corresponding thereto.

7. The vehicle commander control switch of claim 1 wherein said touch pad signal generator continuously generates said scroll command signal while said touch input is on said second outer zone.

8. The vehicle commander control switch of claim 1 further including:
a vehicle support structure on or in which said touch pad is mounted, said touch pad displaceable relative to said support structure between a first position and a second depressed position;
a bias mechanism connected to said support structure to urge said touch pad toward said first position; and
a touch pad movement signal generator for detecting depression of said touch pad when said touch pad is moved to said second position and generating a depression signal corresponding thereto.

9. The vehicle commander control switch of claim 1 further including:
backlighting for illuminating said touch pad, said backlighting including a plurality of colors with each of said plurality of colors corresponding to one of a plurality of system modes of said touch pad such that said touch pad is illuminated with a particular color that corresponds to a particular system mode of said touch pad.

10. The vehicle commander control switch of claim 9 wherein said plurality of system modes include at least two of a navigation mode, an audio mode and an HVAC mode.

11. The vehicle commander control switch of claim 1 further including:
a control unit operatively connected to said touch signal generator for receiving said signals therefrom, said control unit having a navigation mode wherein said touch input from said touch pad operates a vehicle navigation system, said touch pad signal generator in said scroll mode when said control unit is in said navigation mode; and
a display device operatively connected to said control unit, said display device displaying a map when said control unit is in said navigation mode,
wherein said scroll command signal is generated by said touch pad signal generator when said touch input is on said second outer zone with said control unit in said navigation mode and said touch pad signal generator in said scroll mode and said control unit scrolling said map on said display device continuously while said scroll command signal is received.

12. The vehicle commander control switch of claim 11 wherein said touch pad signal generator generates gesture command signals when said touch input is on said first inner zone and said control unit receives said gesture command signals, said control unit reconfiguring said map on said display device based on said gesture command signals.

13. The vehicle commander control switch of claim 12 wherein said gesture command signals include zoom gesture command signals.

14. The vehicle commander control switch of claim 11 wherein a direction along which said map is scrolled corresponds to said location of said touch input on said second outer zone.

15. A commander control switch system for a vehicle, comprising:
a touch pad having a touch surface for receiving touch input thereon, said touch surface including a first central zone and a second zone annularly surrounding said first central zone;
a touch pad signal generator for detecting the location of said touch input on said touch surface and generating signals corresponding thereto;
a display device for displaying display content; and
a control unit operatively connected to said touch signal generator for receiving said signals therefrom and operatively connected to said display device for controlling said display content on said display device, said control unit scrolling said display content on said display device when said touch pad signal generator detects said touch input in said second zone and sends said signals to said control unit corresponding to said touch input in said second zone.

16. The commander control switch system of claim 15 wherein said touch surface is convex and continuous without ridges or depressions from said first zone to said second zone.

17. The commander control switch system of claim 15 wherein a direction of scrolling of said display content on said display device by said control unit corresponds to a location of said touch input in said second zone.

18. The commander control switch system of claim 15 further including:
an annular rotary knob having said touch pad disposed radially therein;
a rotational signal generator for detecting relative rotation of said rotary knob and generating rotational signals corresponding thereto, said control unit operatively connected to said rotational signal generator for receiving said rotational signals therefrom.

19. The commander control switch system of claim 18 wherein said touch pad is axially displaceable between a first position and a second position with a bias mechanism urging said touch pad touch said first position, a touch pad movement signal generator detecting movement of said touch pad into said second position and generating a corresponding movement signal, said control unit operatively connected to said touch pad movement signal generator for receiving said movement signal therefrom.

20. The commander control switch system of claim 15 wherein said control unit continuously scrolls said display content on said display while said touch pad signal generator continuously detects said touch input in said second zone and continuously sends said signals to said control unit corresponding to said touch input in said second zone.

21. The commander control switch system of claim 15 further including:
backlighting for said touch pad, said backlighting including at least a first color and a second color, said backlighting controlled by said control unit such that said backlighting illuminates said touch pad in said first color when said touch pad is operated in a first mode and illuminates said touch pad in said second color when said touch pad is operated in a second mode.

22. A commander control switch method, comprising:
providing a touch pad having a touch surface including a first central zone and a second zone annularly surrounding the first central zone;
generating scroll command signals when touch input is received on said second zone of said touch pad;
receiving said scroll command signals from said touch pad;
displaying display content on a display device; and
scrolling said display content on said display device when said scroll command signals are received.
